(19) United States
(12) Patent Application Publication
(10) Pub. No.: US 2011/0069322 A1
(43) Pub. Date: Mar. 24, 2011

(54) LASER POINTING MECHANISM

(75) Inventor: John M. Hoffer, JR., Willow Street, PA (US)

(73) Assignee: FARO TECHNOLOGIES, INC., Lake Mary, FL (US)

(21) Appl. No.: 12/884,553

(22) Filed: Sep. 17, 2010

Related U.S. Application Data
(60) Provisional application No. 61/244,380, filed on Sep. 21, 2009.

(51) Int. Cl. G01B 11/14

(52) U.S. Cl. 356/615

(57) ABSTRACT

A pointing device for use with a laser tracker or laser scanner may include a tracker or scanner control system and a tracker or scanner plant. The tracker plant may include a plurality of motors configured to apply a torque to a mechanism that steers the laser and a plurality of angular encoders configured to send feedback information on the angular position of the mechanism to the tracker control system. The tracker or scanner control system may be configured such that, when the pointing device is operating in a manual adjustment mode, the tracker or scanner control system controls the plurality of motors to provide a torque to the mechanism opposite to a direction of movement caused by the user.

### CROSS-REFERENCE TO RELATED APPLICATIONS

This application claims the benefit of U.S. Provisional Application Ser. No. 61/244,380 entitled “LASER POINTING MECHANISM”, filed Sep. 21, 2009, which is incorporated herein by reference in its entirety.

### FIELD OF INVENTION

The present invention relates to coordinate measuring devices, and more particularly to systems and methods configured to maintain a laser beam in a fixed direction after it has been manually pointed by the user.

### BACKGROUND

One set of coordinate measurement devices belongs to a class of instruments that measure the three-dimensional (3D) coordinates of a point by sending a laser beam to the point, where it is intercepted by a retroreflector target. The instrument finds the coordinates of the point by measuring the distance and the two angles to the target. The distance is measured with a distance-measuring device such as an absolute distance meter or an interferometer. The angles are measured with an angle-measuring device such as an angular encoder. A gimbaled beam-steering mechanism within the instrument directs the laser beam to the point of interest. Exemplary systems for determining coordinates of a point are described by U.S. Pat. No. 4,790,651 to Brown et al. and U.S. Pat. No. 4,714,339 to Lau et al.

The laser tracker is a particular type of coordinate-measuring device that tracks the retroreflector target with one or more laser beams it emits. A coordinate-measuring device that is closely related to the laser tracker is the laser scanner. The laser scanner steps one or more laser beams to points on a diffuse surface.

A scanner may send the laser beam to any desired location, but a laser tracker usually sends the laser beam to a retroreflector target. A common type of retroreflector target is the spherically mounted retroreflector (SMR), which includes a cube-corner retroreflector embedded within a metal sphere. The cube-corner retroreflector includes three mutually perpendicular mirrors. The apex, which is the common point of intersection of the three mirrors, is located at the center of the sphere. Because of this placement of the cube corner within the sphere, the perpendicular distance from the apex to any surface on which the SMR rests remains constant, even as the SMR is rotated. Consequently, the laser tracker can measure the 3D coordinates of a surface by following the position of an SMR as it is moved over the surface.

A gimbal mechanism within a scanner or laser tracker may direct a laser beam from the scanner or tracker to the desired location or retroreflector. For the laser tracker, part of the light retroreflected by the SMR enters the laser tracker and passes onto a position detector. A control system within the laser tracker can use the position of the light on the position detector to adjust the rotation angles of the mechanical azimuth and zenith axes of the laser tracker to keep the laser beam centered on the SMR. In this way, the tracker is able to follow (track) an SMR that is moved over the surface of an object of interest.

Scanners typically measure distance to the target of interest by using an absolute distance meter. Laser trackers may measure distance using either an interferometer or absolute distance meter (ADM). An interferometer finds the distance from a starting point to a finishing point by counting the number of increments of known length (usually the half-wavelength of the laser light) that pass a fixed point as the retroreflector target is moved between the two points. If the beam is broken during the measurement, the number of counts cannot be accurately known, causing the distance information to be lost. By comparison, an ADM finds absolute distance to a retroreflector target without regard to beam breaks. Because of this, the ADM is said to be capable of “point-and-shoot” measurement.

Both laser trackers and scanners usually measure angles with highly accurate angular encoders. Laser trackers have the ability to follow (track) a rapidly moving retroreflector, but scanners do not usually have this ability. In its most common mode of operation, the laser tracker automatically follows the movements of an SMR when the laser beam from the tracker strikes near enough to the center of the retroreflector.

The scanner or tracker sends the laser beam in a direction that generally changes in time. One possibility is to have a computing device send instructions to the scanner or tracker giving the pattern of angles to which the laser beam is to point. A computing device sending this type of pattern profile to the tracker or scanner is said to be executing a profiler function.

A second possibility, for the case of the laser tracker in tracking mode, is to track the moving SMR. The feedback to enable this tracking comes from laser light that bounces off the retroreflector and re-enters the tracker. Some of this light bounces off a partially reflecting beam splitter and passes to a position detector. The position of this light on the detector is information the tracker control system needs to keep the laser beam centered on the retroreflector.

A third possibility for either scanners or laser trackers is for the user to manually point the laser beam toward a target of interest. In many cases, it is easier to point a laser beam toward a desired direction than to enter coordinates or angles into a computer control. To enable the user to easily move the beam steering mechanism, the motors are temporarily turned off. After the user directs the laser beam to the desired direction, he will remove his hands.

If the gimbal mechanism is perfectly balanced, the laser beam will continue to point in the same direction. If the gimbal mechanism is unbalanced to even the slightest degree, however, the beam will tend to droop or rise from its initial position. By the time the user enables motors to prevent movement of the laser beam, the beam may already be far from the desired direction.

Systems for controlling rotational positions of a movable unit are described by U.S. Pat. No. 7,634,381 to Westermark et al. and U.S. Pat. No. 7,765,084 to Westermark et al.

There is a need for a beam steering mechanism that causes the laser beam to remain fixed in direction after it has been manually pointed by the user.

### SUMMARY OF THE INVENTION

At least one embodiment includes a pointing device for use with a laser tracker or laser scanner which may include a tracker or scanner control system and a tracker or scanner plant. The tracker plant may include a plurality of motors configured to apply a torque to a mechanism that steers the laser and a plurality of angular encoders configured to send feedback information on the angular position of the mechanism to the tracker control system. The tracker or scanner control system may be configured such that, when the pointing device is operating in a manual adjustment mode, the tracker or scanner control system controls the plurality of motors to provide a torque to the mechanism opposite to a direction of movement caused by the user.

An exemplary embodiment includes a pointing device for use with a laser device including a laser that emits a laser beam, the laser being positionable by a user, the pointing device including a control system, a plant operatively coupled to the control system including a plurality of motors configured to apply a torque to a mechanism that steers the laser, angular encoders configured to send feedback information on the angular position of the mechanism to the control system, a position sensing device configured to send information regarding the position of the laser beam on a surface of the position detector to the control system, a master control unit operatively coupled to the control system and the position sensing device, the master control unit including an encoder averager module configured to provide command position readings to the control system, a target positioner module configured to provide target position readings to the control system and a motion profiler module configured to generate command position readings to the control system.

Another exemplary embodiment includes a tracking pointing device for use with a laser tracker including a laser that emits a laser beam to be reflected off a retroreflector, the laser being positionable by a user, the tracking pointing device including a tracker control system and a tracker plant including motors having a zenith motor and an azimuth motor, the zenith motor and the azimuth motor being configured to apply a torque to a mechanism that steers the laser, angular encoders including a zenith angular encoder and an azimuth angular encoder, the zenith angular encoder and the azimuth angular encoder being configured to send feedback information on the angular position of the mechanism to the tracker control system and a position detector configured to send information regarding the position of the laser beam on a surface of the position detector to the tracker control system.

A further exemplary embodiment includes a scanning pointing device for use with a laser scanner including a laser that emits a laser beam, the laser being positionable by a user, the scanning pointing device including a scanner control system and a scanner plant including a motors having a zenith motor and an azimuth motor, the zenith motor and the azimuth motor being configured to apply a torque to a mechanism that steers the laser and angular encoders including a zenith angular encoder and an azimuth angular encoder, the zenith angular encoder and the azimuth angular encoder being configured to send feedback information on the angular position of the mechanism to the scanner control system.

### BRIEF DESCRIPTION OF THE DRAWINGS

Referring now to the drawings, exemplary embodiments are shown which should not be construed to be limiting regarding the entire scope of the disclosure, and wherein the elements are numbered alike in several FIGURES:

FIG. 1 is a perspective view of SMR being measured by laser tracker;

FIG. 2 is a block diagram of laser tracker pointing system;

FIG. 3 is a block diagram of laser scanner pointing system;

FIG. 4 shows another embodiment of the elements of the control system capable of eliminating the problem of imbalance of a beam steering mechanism in a laser tracker or a laser scanner;

FIG. 5 illustrates a position loop and velocity loop in accordance with exemplary embodiments;

FIG. 6 illustrates a current loop in accordance with exemplary embodiments;

FIG. 7 illustrates a flow chart of a method for maintaining a fixed position of a laser beam after it has been manually pointed by the user in accordance with exemplary embodiments; and

FIG. 8 illustrates a processor system that can be implemented in conjunction with the exemplary laser pointing mechanisms described herein.

### DETAILED DESCRIPTION OF THE PREFERRED EMBODIMENTS

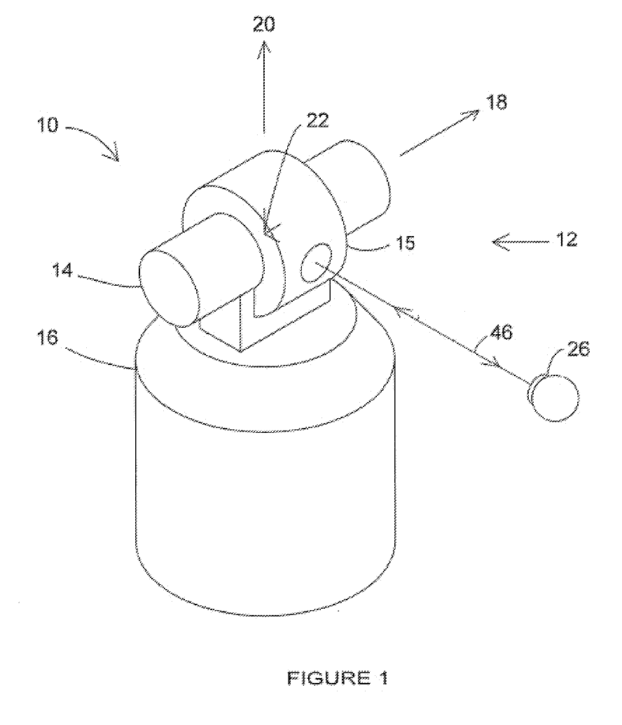

FIG. 1 shows a laser beam being sent from laser tracker 10 to SMR 26, which returns the laser beam to tracker 10. An exemplary gimbaled beam-steering mechanism 12 of laser tracker 10 includes zenith carriage 14 mounted on azimuth base 16 and rotated about azimuth axis 20. Payload 15 is mounted on zenith carriage 14 and rotated about zenith axis 18. Zenith mechanical rotation axis 18 and azimuth mechanical rotation axis 20 intersect orthogonally, internally to tracker 10, at gimbal point 22, which is typically the origin for distance measurements. Laser beam 46 virtually passes through gimbal point 22 and is pointed orthogonal to zenith axis 18. In other words, the path of laser beam 46 is in the plane normal to zenith axis 18. Laser beam 46 is pointed in the desired direction by rotation of payload 15 about zenith axis 18 and by rotation of zenith carriage 14 about azimuth axis 20. Zenith and azimuth angular encoders, internal to the tracker (not shown), are attached to zenith mechanical axis 18 and azimuth mechanical axis 20 and indicate, to high accuracy, the angles of rotation. Laser beam 46 travels to SMR 26 and then back to laser tracker 10. The tracker measures the radial distance between gimbal point 22 and retroreflector 26, as well as the rotation angles about the zenith and azimuth axes 18, 20, to find the position of retroreflector 26 within the spherical coordinate system of the tracker.

In tracking mode, some of the laser light sent back into the tracker from SMR 26 is split off by a partially reflecting beam splitter and sent to position detector (not shown) internal to the tracker. The position of the laser beam on the position detector is used by the laser tracker control system to keep the laser beam pointed at the center of SMR 26.

An alternative to laser tracker 10 is a laser scanner. The laser scanner would not have to be used in conjunction with a cooperative target such as SMR 26 and it would not require a position detector.

As discussed previously, there are three modes of operation that establish the pointing direction of the laser beam. The first mode, as described above, is the tracking mode in which the laser beam from the tracker follows the movement of the retroreflector. With this mode of operation, the tracker motors are turned on and caused to actively adjust the direction of the laser beam to follow the retroreflector target. The tracking mode is not available in laser scanners.

The second mode is the profiler mode, in which the computer sends the tracker or scanner instructions for the desired pattern of pointing angles. With this mode of operation, the tracker motors are turned on and caused to adjust the direction of the laser beam to follow the pattern given by the computer.

The third mode is the user-directed mode, in which the user manually adjusts the direction of the laser beam. Ordinarily, motors are turned off to enable the user to easily steer the laser beam to the desired direction. However, when the user lets go of the beam steering mechanism and before the motors can be turned back on, imperfect balance of the beam steering mechanism may cause the laser beam to change direction.

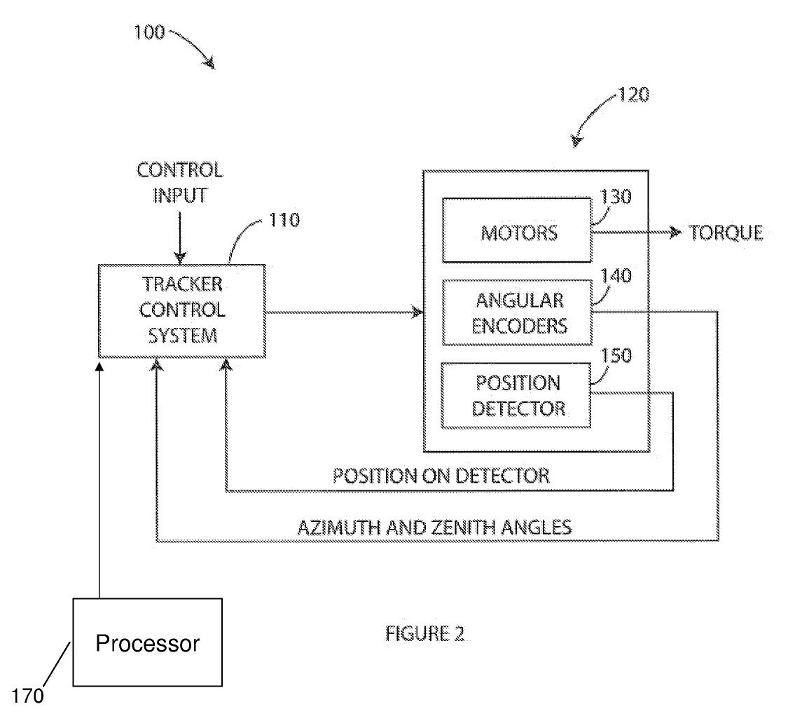

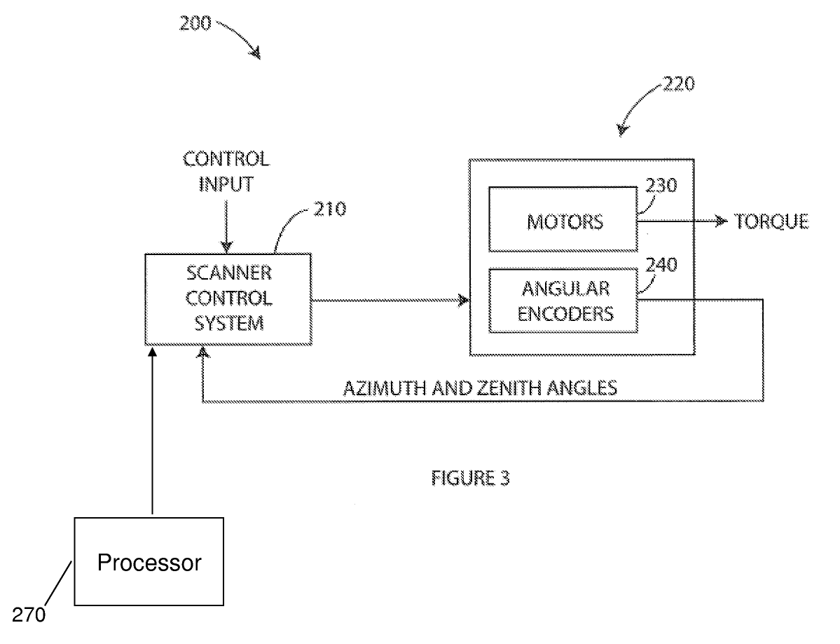

FIG. 2 shows the elements of the control system capable of eliminating the problem of imbalance of the beam steering mechanism in a laser tracker, such as the laser tracker 10 of FIG. 1. In addition, FIG. 3 shows a similar control system within a laser scanner. In FIG. 2, tracker pointing system 100 includes tracker control system 110 and tracker plant 120. Tracker plant 120 includes motors 130, which may include zenith and azimuth motors, angular encoders 140, which may include zenith and azimuth angular encoders, and position detector 150. Motors 130 apply a torque to mechanism that steers the laser beam. Angular encoders 140 send feedback information on angular values to tracker control system 110. Position detector 150 sends information on the position of the laser beam on its surface to tracker control system 110. The tracker operator may select any one of three modes of operation: (1) tracking mode, (2) profiling mode, or (3) manual adjustment mode.

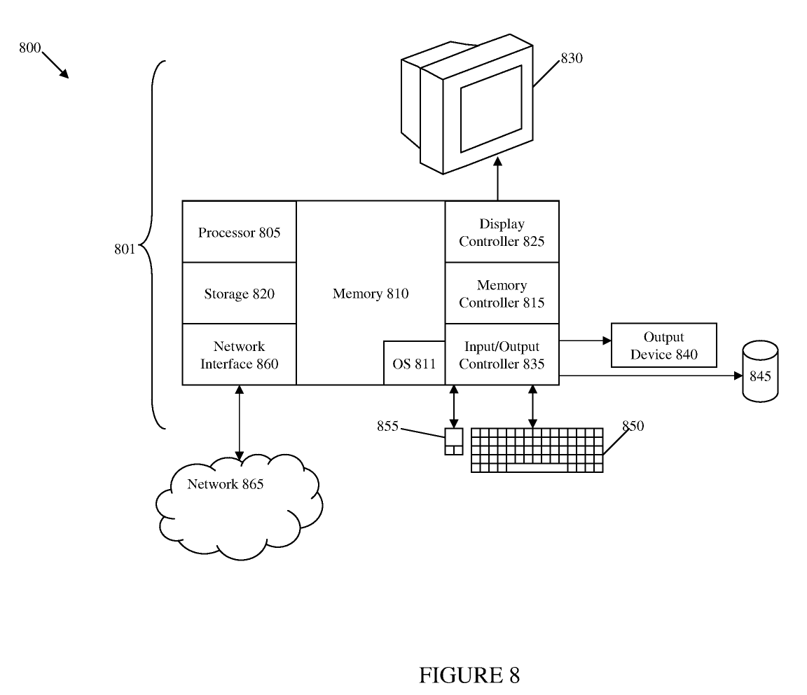

The system 100 can include a processor 170 either integral with or external to the system 100 providing application capabilities and user control of the system 100. Further details of the processor are described herein with respect to FIG. 8.

FIG. 3 shows the elements of the control system capable of eliminating the problem of imbalance of the beam steering mechanism in a laser scanner. Laser scanner pointing system 200 includes scanner control system 210 and tracker plant 220. Tracker plant 220 includes motors 230, which may include zenith and azimuth motors and angular encoders 240, which may include zenith and azimuth angular encoders. Motors 230 apply a torque to mechanism that steers the laser beam. Angular encoders 140 send feedback information on angular values to scanner control system 210.

The system 200 can include a processor 270 either integral with or external to the system 200 providing application capabilities and user control of the system 200. Further details of the processor are described herein with respect to FIG. 8.

Referring again to FIG. 2, the tracker operator may select any one of two modes of operation: (1) profiling mode or (2) manual adjustment mode. In tracking mode, tracker control system 110 keeps laser beam 46 centered on SMR 26 even as the SMR 26 moves rapidly. The control system may be a simple proportional-integral-derivative (PID) type, or it may be more complex. For example, it may include feed-forward (FF) elements as well as PID components, or it may also be of the cascaded type, including position and velocity loops. The purpose of the control loop is to control the velocity or position of the laser beam movement to match that of the SMR movement.

In profiling mode, tracker control system 110 or scanner control system 210 directs the laser beam to profiled angles or coordinates sent from the computer to the tracker or scanner. The purpose of the control loop is to control the velocity or position of the laser beam movement to match that of the profiled values.

In user adjustment mode, tracker control system 110 or scanner control system 210 directs the laser beam while resisting external forces, which may be the forces of gravity (due to imperfect balancing) or the forces of redirection by the user. This is achieved by having the control system act to resist velocities other than zero or, equivalently, to resist changes in pointing direction of the laser beam. The force applied by the control system is designed to be non-responsive to the very small forces of gravity, but to apply a torque to the hand of the user in opposition to manual adjustment. The force is set to a reasonable level so that the operator can turn the beam without applying excessive force.

In the case of the laser tracker, one valuable use for the user adjustment mode is to aim the laser beam in close proximity to a retroreflector target, and then invoke an automated search routine to quickly lock onto the target. As an alternative to invoking an automated search routine, a camera mounted on the tracker may be used to direct the laser beam 46 to the center of the SMR 26. LEDs mounted proximate the camera can be used to repetitively illuminate the SMR 26, thereby simplifying camera identification of the retroreflector target.

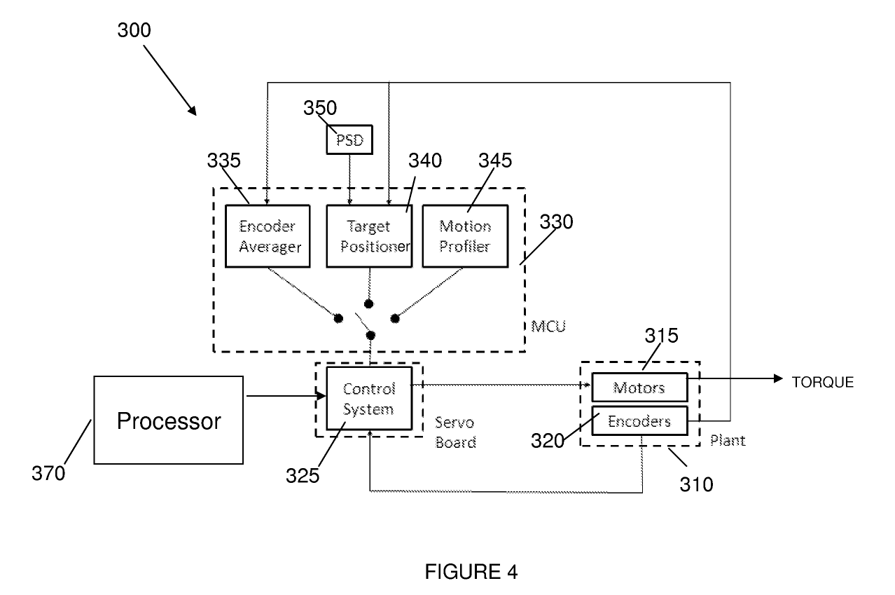

FIG. 4 shows another embodiment of the elements of the control system 300 capable of eliminating the problem of imbalance of the beam steering mechanism in a laser tracker such as the laser tracker 10 of FIG. 1. In other exemplary embodiments, the system 300 can be modified to be implemented with a laser scanner. In FIG. 4, the system 300 includes a plant 310 operatively coupled to a control system 325 and a master control unit (MCU) 330. The plant 310 can include a motor 315 and rotary encoders 320. The motors 315 can be brushless DC motors that take the current driven from a control system 325 and convert it to torque that steers the laser beam. The motors 315 can include zenith and azimuth motors. The rotary encoders 320 provide angular position feedback of the axes and can include zenith and azimuth angular encoders. The control system 325 takes a specified command position from the MCU 330 combined with the encoder feedback from the plant 310 to determine how to drive current to the motors 315 in such a way as to make the angular encoders 320 readings match the command position. The MCU 330 provides much of the functionality of the tracker, and one of its roles is to calculate command positions. There can be three sources of command positions: 1) encoder averager 335; 2) target positioner 340; and 3) motion profiler 345. Furthermore, the system 300 can include two modes of operation in which the sources of command positions operate. In a first mode, a “Hold Position Mode”, the motors 315 operate to return one or more of the axes 18, 20 to a fixed location as further described herein. In the “Hold Position Mode”, the system 300 holds the last known position of the target or if the system 300 is done tracking a target, the system 300 then holds the last known position of the target. In a second mode, a “Hold Velocity Mode”, the motors 315 operate to reduce the velocity of one or more of the axes 18, 20 to a zero velocity. When in the “Hold Velocity Mode”, the system 300 is generating tracking positions of the target. When the system 300 is done tracking positions, the system 300 holds itself at a zero velocity. In both modes, the motors 315 apply a torque in the opposite direction of an external force acting on the axes 18, 20.

The encoder averager 335 generates command positions if the “Hold Velocity Mode” is set and tracking is off or if there is no beam in the beam path. In this scenario, the MCU 330 reads the encoders 320 and calculates an average value. If no external force acts on the axis (i.e. someone doesn't push on it, etc.), the command position matches the current encoder reading. If an external force is applied, the average encoder reading will lag the most recent encoder reading. When the average encoder reading is provided as a command position to the control system 325, the control system 325, in its attempt to make the encoder reading match the command position, will push back in the opposite direction of the external force attempting to resist the motion.

When the tracker is set to have “Tracking Mode” “On” and the tracker recognizes that a target is in the beam path, the target position 340 calculates the target location using a Position Sensing Device (PSD) 350, angular encoders 320, and the distance to the target. This calculated target location is then sent to the control system 325 as the command position. As the target is moved, a new command position is sent to the control system 325, which causes it to track the location of the target.

The motion profiler 345 generates command positions in several situations. In one situation, in which tracking is off and “Hold Position Mode” is set, the motion profiler 345 outputs the same value over and over again. This value may be the last known location of a target, the last position of a profiled move, or the position the axis was pointed when the motors were turned on. A situation in which no beam is in the beam path and “Hold Position Mode” is set is the same as “Tracking is off.” In the third situation in which, the tracker has been requested to point in a new location, a request to point the tracker in a new direction is generated. In this situation, the motion profiler 345 takes the current command position and the new requested location and then computes a series of command positions that are sent to the control system 325 such that the axis turns with a trapezoidal velocity profile.

The system 300 can include a processor 370 either integral with or external to the system 300 providing application capabilities and user control of the system 300. Further details of the processor are described herein with respect to FIG. 8.

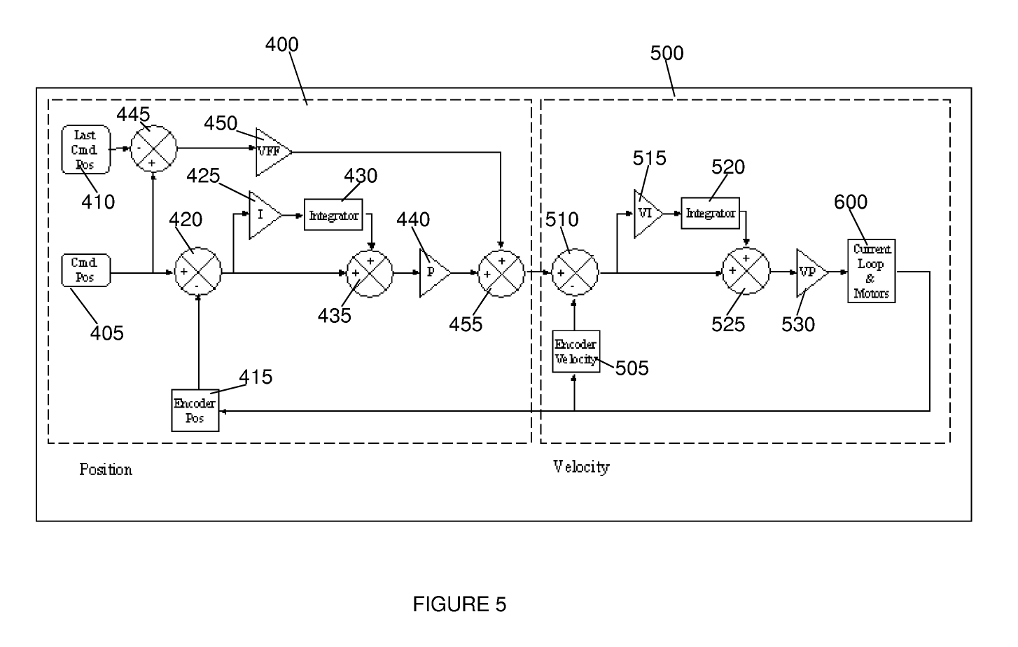

FIG. 5 illustrates a position loop 400 and velocity loop 500 in accordance with exemplary embodiments. In the position loop 400, a command position node (Cmd Pos) 405 represents the location provided by the MCU 330, which is the reading desired out of the angular encoders 320. A last command position node (Last Cmd Pos) 410 represents the previous command position provided by the MCU 330. Whenever the MCU 330 issues a new command position, the current value in “Cmd Pos” 405 is copied to “Last Cmd Pos.” 410. An encoder position node (Encoder Pos) 415 is the angular position feedback of the axis location.

The difference between the Cmd Pos 405 and the Encoder Pos 415 is calculated, at difference node 420, and is referred to as “position delta”. The position delta is multiplied by the position integrator gain (I) 425 and then summed with previous values by an integrator 430, which adjusts the output of the position loop over time when a constant error exists. The position delta is added to the output of the integrator at an addition node 435 and multiplied by the position gain (P) 440. The difference between Last Cmd Pos. 410 and the Cmd Pos 405, calculated at difference node 445, is multiplied by a velocity feed forward gain (VFF) 450, which provides a boost to the output of the position loop when Cmd Pos 405 is changing. The velocity feed forward term and the output after applying the P gain are added together at addition node 455 to produce the output of the position loop, which is a command velocity for the velocity loop 500.

Referring to the velocity loop 500, an encoder velocity node 505 represents the rate of change of the encoder reading. The encoder velocity is subtracted from the command velocity (output of the position loop 400) at difference node 510 to create a velocity delta. The velocity delta is multiplied by a velocity integrator gain (VI) 515 and then summed with previous values by an integrator 520, which adjusts the output of the velocity loop 500 over time when a constant error exists. The velocity delta is added to the output of the integrator at addition node 525 and multiplied by the velocity gain (VP) 530. This output is the command input to the current loops 600, as now described.

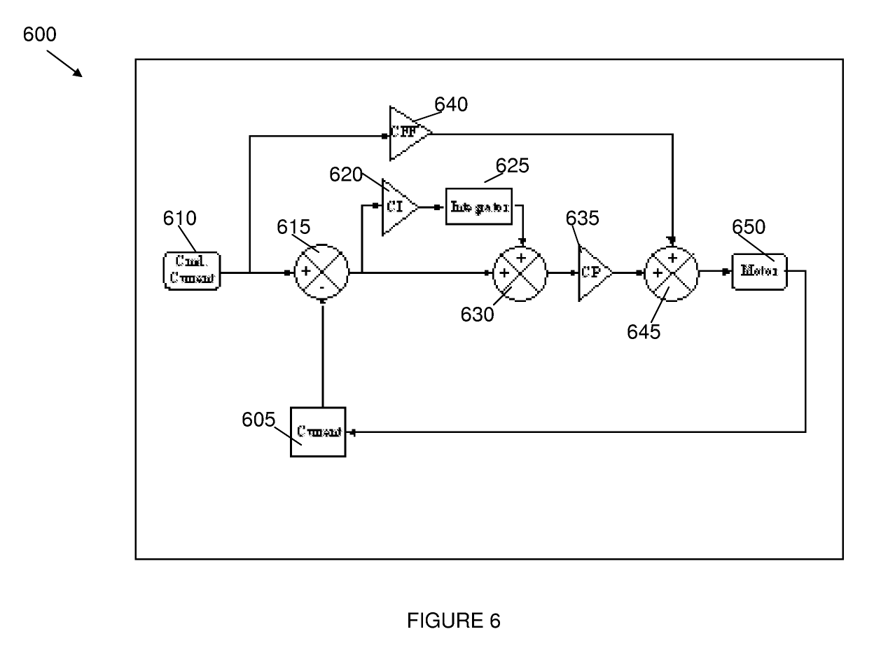

FIG. 6 illustrates a current loop 600 in accordance with exemplary embodiments. The current 605 is the reading for the amount of current flowing through the motors as measured by a sensor. The current 605 is subtracted from the command current 610 (output of the velocity loop 500) at difference node 615 to create a current delta. The current delta is multiplied by the current integrator gain (CI) 620 and then summed with previous values by an integrator 625, which adjusts the output of the current loop over time when a constant error exists 600. The current delta is added to the output of the integrator 625 at addition node 630 and multiplied by a current gain (CP) 635. The command current 610 is multiplied by a feed forward term (CFF) 640. The feed forward term 640 and the output after applying the CP gain 635 are added together at addition node 645 to produce the output of to the motors 650.

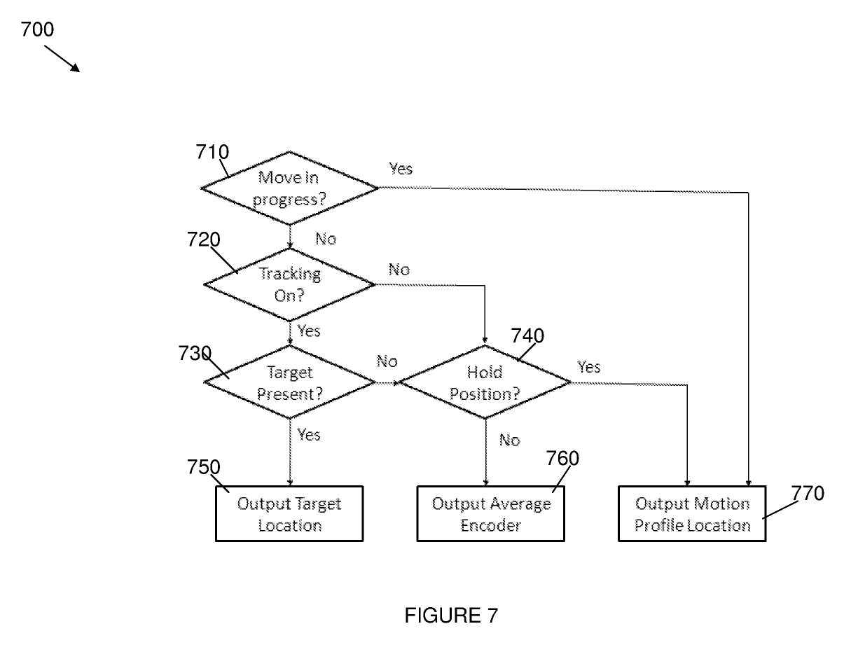

FIG. 7 illustrates a flow chart of a method 700 for maintaining a fixed position of a laser beam after it has been manually pointed by the user in accordance with exemplary embodiments. The method 700 can be implemented by any of the exemplary systems described herein. The system determines if there is a move of the laser beam in progress at block 710. If there is a move in progress at block 710, then the system outputs the motion profile location at block 770 as described herein. If the laser beam is not moving at block 710, then the system determines if tracking is on at block 720. If tracking is not on at block 720, then the system determines whether to hold position at block 740. If the system determines to hold position at block 740, then the system outputs the motion profile location at block 770 as described herein. If at block 740, the system determines not to hold position, then at block 760, the system outputs the average encoder reading as described herein. If at block 720, the system determines that tracking is on, then at block 730, the system determines if the target is present. If the target is not present at block 730, then the system proceeds to block 740 as described above. If at block 730, the system determines that the target is present, then at block 750, the system outputs the target location at block 750 as described herein.

As described herein, the exemplary systems 100, 200, 300 can respectively include a processor 170, 270, 370 either integral with or external to the system 100, 200, 300 providing application capabilities and user control of the system 100, 200, 300. The processor 170, 270, 370 can be an integral or separate processing system as now described with respect to FIG. 8, which illustrates a processor system 800 that can be implemented in conjunction with the exemplary laser pointing mechanisms described herein.

The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 800 therefore includes general-purpose computer 801.

In exemplary embodiments, in terms of hardware architecture, as shown in FIG. 8, the computer 801 includes a processor 805, memory 810 coupled to a memory controller 815, and one or more input and/or output (I/O) devices 840, 845 (or peripherals) that are communicatively coupled via a local input/output controller 835. The input/output controller 835 can be, but is not limited to, one or more buses or other wired or wireless connections, as is known in the art. The input/output controller 835 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 805 is a hardware device for executing software, particularly that stored in memory 810. The processor 805 can be any custom made or commercially available processor, a central processing unit (CPU), an auxiliary processor among several processors associated with the computer 801, a semiconductor based microprocessor (in the form of a microchip or chip set), a macroprocessor, or generally any device for executing software instructions.

The memory 810 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 810 may incorporate electronic, magnetic, optical, and/or other types of storage media. Note that the memory 810 can have a distributed architecture, where various components are situated remote from one another, but can be accessed by the processor 805.

The software in memory 810 may include one or more separate programs, each of which includes an ordered listing of executable instructions for implementing logical functions. In the example of FIG. 8, the software in the memory 810 includes the laser pointing methods described herein in accordance with exemplary embodiments and a suitable operating system (OS) 811. The operating system 811 essentially controls the execution of other computer programs, such the laser pointing systems and methods as described herein, and provides scheduling, input-output control, file and data management, memory management, and communication control and related services.

The laser pointing methods described herein may be in the form of a source program, executable program (object code), script, or any other entity including a set of instructions to be performed. When a source program, then the program needs to be translated via a compiler, assembler, interpreter, or the like, which may or may not be included within the memory 810, so as to operate properly in connection with the OS 811. Furthermore, the laser pointing methods can be written as an object oriented programming language, which has classes of data and methods, or a procedure programming language, which has routines, subroutines, and/or functions.

In exemplary embodiments, a conventional keyboard 850 and mouse 855 can be coupled to the input/output controller 835. Other output devices such as the I/O devices 840, 845 may include input devices, for example but not limited to a printer, a scanner, microphone, and the like. Finally, the I/O devices 840, 845 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 800 can further include a display controller 825 coupled to a display 830. In exemplary embodiments, the system 800 can further include a network interface 860 for coupling to a network 865. The network 865 can be an IP-based network for communication between the computer 801 and any external server, client and the like via a broadband connection. The network 865 transmits and receives data between the computer 801 and external systems. In exemplary embodiments, network 865 can be a managed IP network administered by a service provider. The network 865 may be implemented in a wireless fashion, e.g., using wireless protocols and technologies, such as WiFi, WiMax, etc. The network 865 can also be a packet-switched network such as a local area network, wide area network, metropolitan area network, Internet network, or other similar type of network environment. The network 865 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 801 is a PC, workstation, intelligent device or the like, the software in the memory 810 may further include a basic input output system (BIOS) (omitted for simplicity). The BIOS is a set of essential software routines that initialize and test hardware at startup, start the OS 811, and support the transfer of data among the hardware devices. The BIOS is stored in ROM so that the BIOS can be executed when the computer 801 is activated.

When the computer 801 is in operation, the processor 805 is configured to execute software stored within the memory 810, to communicate data to and from the memory 810, and to generally control operations of the computer 801 pursuant to the software. The laser pointing methods described herein and the OS 811, in whole or in part, but typically the latter, are read by the processor 805, perhaps buffered within the processor 805, and then executed.

When the systems and methods described herein are implemented in software, as is shown in FIG. 8, the methods can be stored on any computer readable medium, such as storage 820, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the laser pointing methods are implemented in hardware, the laser pointing methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

While preferred embodiments have been shown and described, various modifications and substitutions may be made thereto without departing from the spirit and scope of the invention. Accordingly, it is to be understood that the present invention has been described by way of illustrations and not limitation.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A pointing device for use with a laser device comprising a laser that emits a laser beam, the laser being positionable by a user, the pointing device comprising:
a control system; and
a plant operatively coupled to the control system comprising:
a plurality of motors configured to apply a torque to a mechanism that steers the laser;
a plurality of angular encoders configured to send feedback information on the angular position of the mechanism to the control system;
a position sensing device configured to send information regarding the position of the laser beam on a surface of the position detector to the control system;
a master control unit operatively coupled to the control system and the position sensing device, the master control unit comprising:
an encoder averager module configured to provide command position readings to the control system;
a target positioner module configured to provide target position readings to the control system; and
a motion profiler module configured to generate command position readings to the control system.

2. The pointing device as claimed in claim 1 wherein the control system is configured such that, when the pointing device is operating in a manual adjustment mode, the control system controls the motor to provide a torque to the mechanism opposite to a direction of movement caused by the user.

3. The pointing device as claimed in claim 1 wherein the target positioner module calculates the target position readings while configured in a tracking mode.

4. The pointing device as claimed in claim 1 wherein the motion profiler module generates the command positions to the control system in response to position changes of the laser device.

5. The pointing device as claimed in claim 4 wherein the motion profiler module outputs a constant value while in a hold position mode.

6. The pointing device as claimed in claim 5 wherein the constant value is a last known target position reading.

7. The pointing device as claimed in claim 5 wherein the constant value is a last position of a profiled move.

8. The pointing device as claimed in claim 5 wherein the constant value is a laser beam position reading when the plurality of motors were powered on.

9. The pointing device as claimed in claim 1 wherein the encoder averager module generates the command positions to the control system in response to position changes of the laser beam.

10. The pointing device as claimed in claim 4 wherein the master control unit computes an average of the command positions generated by the encoder averager module.

11. The pointing device as claimed in claim 10 wherein the average of the command positions is equal to a recent command position reading output by the encoder averager module in response to no external force acting on the laser device.

12. The pointing device as claimed in claim 10 wherein the average of the command positions lags a recent command position reading in response to an external force acting on the laser device.

13. The pointing device as claimed in claim 10 wherein the plurality of motors generates a torque in an opposite direction of the external force while in a hold velocity mode.

14. The pointing device as claimed in claim 1 wherein the plurality of motors are configured to generate a torque in an opposite direction of an external force acting on the laser device.

15. The pointing device as claimed in claim 14 wherein the plurality of motors is configured to return the laser beam to a known position.

16. The pointing device as claimed in claim 14 wherein the plurality of motors is configured to reduce a velocity of the laser device to a zero velocity.

17. A tracking pointing device for use with a laser tracker comprising a laser that emits a laser beam to be reflected off a retroreflector, the laser being positionable by a user, the tracking pointing device comprising:
a tracker control system; and
a tracker plant comprising:
a plurality of motors comprising a zenith motor and an azimuth motor, the zenith motor and the azimuth motor being configured to apply a torque to a mechanism that steers the laser;
a plurality of angular encoders comprising a zenith angular encoder and an azimuth angular encoder, the zenith angular encoder and the azimuth angular encoder being configured to send feedback information on the angular position of the mechanism to the tracker control system; and
a position detector configured to send information regarding the position of the laser beam on a surface of the position detector to the tracker control system.

18. The tracking pointing device as claimed in claim 17 wherein the tracker control system is configured such that, when the tracking pointing device is operating in a manual adjustment mode, the tracker control system controls the zenith motor and the azimuth motor to provide a torque to the mechanism opposite to a direction of movement caused by the user.

19. The tracking pointing device as claimed in claim 14 wherein the plurality of motors is configured to return the laser beam to a known position.

20. The tracking pointing device as claimed in claim 14 wherein the plurality of motors is configured to reduce a velocity of the laser device to a zero velocity.

21. A scanning pointing device for use with a laser scanner comprising a laser that emits a laser beam, the laser being positionable by a user, the scanning pointing device comprising:
a scanner control system; and
a scanner plant comprising:
a plurality of motors comprising a zenith motor and an azimuth motor, the zenith motor and the azimuth motor being configured to apply a torque to a mechanism that steers the laser; and
a plurality of angular encoders comprising a zenith angular encoder and an azimuth angular encoder, the zenith angular encoder and the azimuth angular encoder being configured to send feedback information on the angular position of the mechanism to the scanner control system.

22. The scanning pointing device as claimed in claim 21 wherein the scanner control system is configured such that, when the scanning pointing device is operating in a manual adjustment mode, the scanner control system controls the zenith motor and the azimuth motor to provide a torque to the mechanism opposite to a direction of movement caused by the user.

23. The scanning pointing device as claimed in claim 21 wherein the plurality of motors is configured to return the laser beam to a known position.

24. The scanning pointing device as claimed in claim 21 wherein the plurality of motors is configured to reduce a velocity of the laser device to a zero velocity.
